(19) United States
(12) Patent Application Publication
(10) Pub. No.: US 2003/0073604 A1
(43) Pub. Date: Apr. 17, 2003

(54) Detergent product

(75) Inventors: Matthew Grady McGoff, Cincinnati, OH (US); Hossam Hassan Tantawy, Morpeth (GB); Phillip Jan Howard, Consett (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/116,480

(22) Filed: Apr. 4, 2002

(30) Foreign Application Priority Data
Apr. 4, 2001 (GB) 0108468.0

(51) Int. Cl. C11D 17/00

(52) U.S. Cl. 510/441; 510/446; 510/475; 510/530

(57) ABSTRACT

The present invention relates to a water-soluble and/or a water-dispersible particle having: a mean particle diameter of less than 20 mm, preferably less than 2 mm; a hardness (H) of 500 MPa or less, when measured at a temperature of 20° C., a relative humidity of 40%; and a fracture toughness (Kc) of 0.04 MPa.m^{1/2} or greater, when measured at a temperature of 20° C., a relative humidity of 40% and a strain rate of from 1×10⁻⁴ to 1×10⁴ s⁻¹, said particle comprises an active ingredient and a matrix suitable for delivering said active ingredient to an aqueous environment, said particle is not freeze dried.

### CROSS REFERENCE TO RELATED APPLICATIONS

This application claims the benefit of Great Britain Patent Application No. GB108468.0 filed on Apr. 4, 2001.

### TECHNICAL FIELD

The present invention relates to water-soluble and/or water dispersible particles. The invention also relates to compositions containing the water-soluble and/or water dispersible particles, and methods for making the particles.

### BACKGROUND OF THE INVENTION

Compositions such as cleaning products and personal-care products, cosmetics and pharmaceuticals, often comprise active ingredients which are to be delivered to water or which are required to be active in aqueous conditions, but which are sensitive to moisture, temperature changes, light and/or air during storage. Also, these compositions often contain ingredients which may react with one another. For example enzymes, used in detergents, are often incompatible with alkaline or acid materials, bleaches, moisture and light, and, thus, coated to protect them.

Attempts have been made to produce enzyme particles which are more stable, for example freeze-drying processes have been used to produce enzyme particles, such as described in EP320483. However, freeze-drying is a very expensive, time consuming and inefficient way to obtain enzyme particles. The freeze drying step is not always compatible with all enzymes, especially freeze-thaw intolerant enzymes. This limits the usefulness of such a process for preparing enzyme particles and particles comprising other active ingredients.

Other attempts have been to produce enzyme particles which are more stable, which are made by a non-freeze drying process. For example, enzyme cores have been coated with one or more layers of coating material(s) to obtain enzyme particles, such as described in EP862623. Therefore, such ingredients or actives are often protected or separated from one another by coating agents. Because the active materials generally need to be delivered in aqueous conditions, the coating materials need to be chosen such that the coating and actives dissolve or disperse well in water.

However, these processes produce particles which generate dust during handling and processing in a manufacturing plant, due to physical forces exerted on them. Indeed, even enzyme particles produced by freeze-drying processes may also generate dust during handling and processing in a manufacturing plant. This not only creates waste product, but the dust can also cause hygiene and health problems. The problem with these particles is that they are not robust enough to withstand the forces which occur during handling and processing of the particles, which results in the generation of dust. One solution to reduce dust formation that is proposed in the prior art, is to make these particles harder.

The Inventors have now overcome the above problems by providing a particle which is capable of delivering an active ingredient to an aqueous environment, which is produced by a non-freeze drying process, and which exhibits low- or nil-dust generation during handling and processing in a manufacturing plant. The particles are produced in a cost-efficient manner, and do not pose the health and hygiene risks associated with the processing of current enzyme particles.

The Inventors have found that instead of making the particles harder, the particles should have a low hardness (H) and a high fracture toughness (Kc), which makes the particles very robust to the forces applied to the particle during handling and processing in a manufacturing plant. Thus, the resulting particles have been found to be very attrition resistant, thus resulting in reduced break-up or abrasion during handling, and, thus, reduced dust formation. The active ingredient(s) incorporated in the particle are also effectively protected, not only against air-moisture and chemical reactions, but also against physical forces.

### SUMMARY OF THE INVENTION

In a first embodiment of the present invention there is provided, a water-soluble and/or a water-dispersible particle having: a mean particle diameter of 20 mm or less, preferably 2 mm or less; a Hardness (H) of 500 MPa or less, when measured at a temperature of 20° C., a relative humidity of 40%; and a Fracture Toughness (Kc) of 0.04 MPa.m^{1/2} or greater, when measured at a temperature of 20° C., a relative humidity of 40% and a strain rate of from 1×10⁻⁴ to 1×10⁴ s⁻¹. The particle comprises an active ingredient and a matrix suitable for delivering the active ingredient to an aqueous environment. The particle is not a freeze dried particle.

In a second embodiment of the present invention there is provided, a process to obtain a particle. The process comprises: mixing the matrix, an active ingredient and optionally other adjunct ingredients to form a mixture, forming the mixture into particles, with the proviso that the process does not comprise a freeze-drying step.

In a third embodiment of the present invention, a process to obtain a particle is provided. The process comprises the steps of: (a) mixing the active ingredient, or part thereof, and the matrix, or part thereof, to form a mixture; and (b) extruding the mixture through an aperture onto a receiving surface, to form a particle; and (c) drying the particle; and (d) releasing the particle from the receiving surface; and (e) optionally, coating the particle with a polymeric material using standard coating techniques; (f) optionally, adding an antioxidant into the mixture and/or particle, at any stage in the process, preferably during step (d); and (g) optionally, deliberately introducing a gas into the mixture and/or particle, at any stage in the process, preferably during step (a).

In a fourth embodiment of the present invention there is provided, a detergent composition comprising the particle. In a fifth embodiment of the present invention there is provided, the use of particle to minimize, reduce or prevent the generation of dust. All documents cited are, in relevant part, incorporated herein by reference; the citation of any document is not to be construed as an admission that it is prior art with respect to the present invention.

### DETAILED DESCRIPTION OF THE INVENTION

Particle

The particle comprises an active ingredient and a matrix suitable for delivering the active ingredient to an aqueous environment. The active ingredient and matrix are described in more detail hereinafter. Preferably, the particle comprises additional adjunct ingredients. These ingredients are described in more detail hereinafter.

The particle according the present invention, herein referred to as “the particle”, is water-soluble and/or water dispersible.

Preferably, the particle has a water-solubility of at least 50%, preferably at least 75% or even at least 95%, as measured by the gravimetric method set out below using a glass-filter with a maximum pore size of 20 microns. Preferably, the particle has a water-dispersability of at least 50%, preferably at least 75% or even at least 95%, as measured by the gravimetric method set out below using a glass-filter with a maximum pore size of 50 microns.

Gravimetric Method for Determining Water-Solubility or Water-Dispersability of Particles

10 grams±0.1 gram of particles are added in a pre-weighed 400 ml beaker, and 245 ml±1 ml of distilled water is added. This is stirred vigorously with a magnetic stirrer set at 600 rpm, for 30 minutes. Then, the solution is filtered through a folded qualitative sintered-glass filter with the pore sizes as defined above (max. 20 or 50 microns). The collected filtrate is dried by any conventional, and the weight of the remaining particles is determined (which is the dissolved or dispersed fraction). Then, the % solubility or dispersability can be calculated.

The particle has a hardness (H) of 500 MPa or less, preferably 200 MPa or less, preferably 100 MPa or less, or 75 MPa or less, or 50 MPa or less, or 25 MPa or less, or 10M Pa or less, or 1 MPa or less, or 0.1 MPa or less, or 0.01 MPa or less, or 0.001 MPa or less. The hardness is preferably greater than 0 Pa, or 1 Pa or greater. Preferably, the hardness is from 1 Pa to 500 MPa, or from 1 Pa to 200 MPa. The H values given herein are when measured at a temperature of 20° C. and a relative humidity of 20%. The H values are measured by the test method described in Oil & Gas Science and Technology Review, Vol. 55 (2000), no. 1, pages 78-85. The hardness values defined in the invention relate to either the internal or external hardness of the particle. Preferably both the internal and external hardness of the particle has the values defined. Particles having a hardness within the ranges, and preferred ranges, described herein, are more resistant to surface wear and tearing, and thus, less likely to generate dust during handling or processing.

The particle has a fracture toughness (Kc) of 0.04 MPa.m^{1/2} or greater, preferably 0.1 MPa.m^{1/2} or greater, or 0.5 MPa.m^{1/2} or greater, or 1 MPa.m^{1/2} or greater, or 1.5 MPa.m^{1/2} or greater, or 2 MPa.m^{1/2} or greater, or 2.5 MPa.m^{1/2} or greater, or 5MPa.m^{1/2} or greater, or 7 MPa.m^{1/2} or greater, or 20 MPa.m^{1/2} or greater, or 15 MPa.m^{1/2} or greater, or 30 MPa.m^{1/2} or greater, or 20 MPa.m^{1/2} or greater, or 25 MPa.m^{1/2} or greater, or 30 MPa.m^{1/2} or greater, or 40 MPa.m^{1/2} or greater, or 50MPa.m^{1/2} or greater. The Kc values given herein are when measured at a temperature of 20° C., a relative humidity of 40% and a strain rate of from 1×10⁻⁴ to 1×10⁴⁻¹.

The Kc values described hereinabove are measured by the indentation fracture test method described in Oil & Gas Science and Technology Review, Vol 55 (2000), no. 1, pages 78-85. If a Kc value cannot be measured by this indentation fracture test method, this is because the Kc value of the particle being tested is too high to enable the particle to be cracked so that no measurement can be made. In the event that the Kc value cannot be measured by the indentation test (because no crack can be formed), then the Kc value is measured by the notch fracture test method described in Introduction to Polymers, 2^{nd} edition, by Young, R. J., and Lovell, P., A., pages 401-407 and the reference therein Development of Fracture Toughness, chapter 5, by Andrew, E., H. If a Kc value cannot be measured by the notch fracture test, this is because the Kc value of the material of the particle being tested is too high. Particles having such a high Kc value that cannot be measured by the notch test, are considered for the purpose of the present invention with regard to their Kc value, to be included within the claims of the present invention. Particles having a Kc within the ranges, and preferred ranges, described herein are more resistant to crack propagation and, thus, less likely to generate dust during processing and handling.

The Inventors have found that the predominant cause of dust generation in a manufacturing plant is crack propagation within the particles. These cracks can develop as a result of high localized stresses applied to the particle.

There are two general mechanisms for crack propagation. First is fragmentation, i.e. production of a small number of large fragments comparable to the size of the particle. Second is chipping, i.e. production of thin platelets from the particle surface. The presence of cracks within the particle, for example due to deformities in the particle structure during processing, can act to further weaken the structure of the particle and result in the generation of dust.

The particle preferably has a ratio of H/Kc² of 312500 Pa⁻¹.m⁻¹ or less, preferably 300000 Pa⁻¹.m⁻¹ or less, or 200000 Pa⁻¹.m⁻¹ or less, or 100000 Pa⁻¹.m⁻¹ or less, or 75000 Pa⁻¹.m⁻¹ or less, or 50000 Pa⁻¹.m⁻¹ or less, or 25000 Pa⁻¹.m⁻¹ or less, or 15000 Pa⁻¹.m⁻¹ or less, or 10000 Pa⁻¹.m⁻¹ or less, or 1000 Pa⁻¹.m⁻¹ or less, or 500 Pa⁻¹.m⁻¹ or less, or 200 Pa⁻¹.m⁻¹ or less, or 100 Pa⁻¹.m⁻¹ or less, or 75 Pa⁻¹.m⁻¹ or less, or 50 Pa⁻¹.m⁻¹ or less, or 40 Pa⁻¹.m⁻¹ or less, or 30 Pa⁻¹.m⁻¹ or less, or 20 Pa⁻¹.m⁻¹ or less, or 10 Pa⁻¹.m⁻¹ or less, or 5 Pa⁻¹.m⁻¹ or less, or 1 Pa⁻¹.m⁻¹ or less, or 0.1 Pa⁻¹.m⁻¹ or less. The particle preferably has a ratio of H/Kc² of greater than 0 Pa⁻¹.m⁻¹, preferably greater than 0.000001 Pa⁻¹.m⁻¹. Preferably, the particle has a ratio of H/Kc² of from 0.000001 Pa⁻¹.m⁻¹ to 312500 Pa⁻¹.m⁻¹, preferably from 0.000001 to 50 Pa⁻¹.m⁻¹. Particles having a ratio of H/Kc² within the ranges, and preferred ranges, specified herein, are more resistant to crack propagation, especially more resistant to chipping and, thus, generate less- or nil-dust during handling and processing in a manufacture plant.

The particle preferably has a ratio of H/Kc of 12500 m⁻¹ or less, preferably 10000 m⁻¹ or less, or 1000 m⁻¹ or less, or 500 m⁻¹ or less, or 200 m⁻¹ or less, or 100 m⁻¹ or less, or 75 m⁻¹ or less, or 50 m⁻¹ or less, or 40 m⁻¹ or less, or 30 m⁻¹ or less, or 20 m⁻¹ or less, or m⁻¹ or less, or 5 m⁻¹ or less, or 1 m⁻¹ or less, or 0.1 m⁻¹ or less. The particle preferably has a ratio of H/Kc of greater than 0 m⁻¹, preferably greater than 0.000001 m⁻¹. Preferably, the particle has a ratio of H/Kc of from 0.000001 m⁻¹ to 12500 m⁻¹, preferably from 0.000001 to 50 m⁻¹. Particles having a ratio of H/Kc within the ranges, and preferred ranges, specified herein, are more resistant to crack propagation, especially more resistant to fragmentation and, thus, generate less- or nil-dust during handling and processing in a manufacture plant.

The particle has a mean particle size of 20 mm or less, preferably 10 mm or less, more preferably 5 mm or less, and even more preferably 1 mm or less. Preferably the particle has a mean particle size of greater than 0 μm, preferably greater than 1 μm. Preferably the particle has a mean particle size from 50 μm to 1000 μm, preferably from 100 μm to 900 μm, preferably from 200 μm to 800 μm, preferably from 300 μm to 700 μm, preferably from 400 μm to 600 μm.

Particles having a mean particle size within the ranges, and preferred ranges, specified herein, are more attrition resistant and generate less- or nil-dust during handling and processing in a manufacturing plant. The inventors have found that particles having a mean particle size within these ranges, are not able to propagate cracks during handling and processing in a manufacturing plant, and, thus, generate less- or nil-dust. The inventors have found that this is especially true for particles having both a mean particle size within the ranges specified herein and having a ratio of H/Kc and/or H/Kc² within the ranges specified herein.

Preferably, the particle is substantially spherical, preferably the particle is a sphere. Substantially spherical particles are more resistant to dust generation.

The particle is preferably viscoelastic. More preferably, the particle is viscoelastic at a temperature of from −35° C. to 60° C.

The viscoelastic nature of the particle can sustain large, often recoverable, deformations without true yield or fracture thereby absorbing the energy of both high & low strain rate stresses. This property allows that the particle and/or matrix to remain unbroken after the physical forces ceases to be applied to the particle, which enables the particle to be resistant to dust generation.

The viscoelasticity of the particle can be characterized by assessing the dynamic-mechanical behaviour in oscillating stress and/or strain conditions where the stress and strain conditions are not in phase with each other. The viscoelasticity can be characterized by these stress & strain responses using mechanical tests known in the art, for example by using the Perkin-Elmer DMA 7e equipment. The elastic character of the particle can be calculated from these dynamic mechanical tests and quoted as storage modulus (E′). The viscous character of the polymer can be calculated from these dynamic mechanical tests and quoted as loss modulus (E″).

The particle typically has a storage modulus (E′_{particle}) of less than 4000 GPa, preferably less than 2000 GPa, or less than 1000 GPa, or less than 500 GPa, or less than 100 GPa, or less than 10 GPa, or less than 1 GPa, or less than 0.1 GPa, or less than 0.01 GPa, or less than 0.001 GPa, or less than 0.0001 GPa at a temperature of from −35° C. to 60° C., typically as measured with the Perkin-Elmer DMA 7e equipment.

It may be preferred that the particle, or part thereof, is in the form of a foam. The particle may have a relative density of less than 1, preferably less than 0.9, or less than 0.8, or less than 0.7, or less than 0.6, or less than 0.5, or less than 0.25, or less than 0.1. Alternatively, the particle, or part thereof, may be in the form of a non-foam. Preferably, the particle is not a foam. The particle may have a relative density of approximately 1.

The relative density is defined as:

$${ρ}_{rel} = \frac{{ρ}_{particle}}{{ρ}_{components}}$$

where ρᵣₑₗ is the relative density of the particle, and ρ_{particle} is the density of particle, and ρ_{components} is the density of the components of the particle.

By changing the relative density of the particle, especially lowering the relative density, the particle becomes more resistant to dust generation.

In a preferred embodiment of the present invention, the matrix is in the form of a foam.

Preferably the particle is flexible, preferably such that the strain at which the particle yields (the limit of elastic deformation of the particle), herein defined as “the relative yield strain” is preferably greater than 2%, and preferably greater than 15%, or greater than 50% at a temperature of from −35° C. to 60° C., as measured with the Perkin-Elmer DMA 7e equipment.

Matrix

The matrix preferably comprises a polymeric material and optionally a plasticizer. Preferably, the matrix itself is water-soluble and/or water-dispersible, and has similar or the same water-solubility and/or water-dispersibility properties as described hereinabove for the particle.

The matrix preferably has a glass transition temperature (Tg) of 60° C. or less, preferably 50° C. or less, or 40° C. or less, or 35° C. or less, and preferably to −100° C., or to −50° C., or to −35° C., or to −20° C., or to −10° C. Particles comprising a matrix having a Tg within the ranges specified herein, generate less- or nil-dust during handling and processing in a manufacture plant. Preferably, the Tg properties of the matrix are achieved by using a polymeric material and a suitable amount of plasticizer. The polymeric material and the plasticizer are described in more detail hereinafter.

The glass transition temperature as used herein is as defined in the text book ‘Dynamic Mechanical Analysis’ (page 53, FIG. 3.11c on page 57), being the temperature of a material (matrix) where the material (matrix) changes from glassy to rubbery, namely where chains gain enough mobility to slide by each other. The Tg of the matrix can be measured with the Perkin-Elmer DMA 7e equipment, following the directions in operations manual for this equipment, generating a curve as illustrated in the book Dynamic Mechanical Analysis—page 57, FIG. 3-11c. The Tg is the temperature as measured with this equipment, between the glass and ‘leathery region’, as defined in that text.

Preferably, the polymeric material is water-soluble and/or water-dispersible, and has similar water-solubility and/or water-dispersibility properties as described hereinabove for the particle. Preferably, the polymeric material has similar Tg properties as described hereinabove for the matrix.

Preferably, the polymeric material comprises an amorphous or semi-crystalline polymer. The polymeric material may consist of a single type of homologous polymer or may be a mixture of polymers. Mixtures of polymers may in particular be beneficial to control the mechanical and/or dissolution properties of the particle, depending on the application and the requirements thereof.

The polymeric material may comprise cellulosic material or derivatives thereof including carboxymethyl cellulose, methyl cellulose, hydroxy ethyl cellulose, hydroxy propyl methyl cellulose, hydroxy propyl cellulose, and combinations thereof.

The polymeric material may comprise a starch. Preferred starches include, raw starch, pre-gelatinized starch and modified starch derived from tubers, legumes, cereal and grains. Preferred starches are dextrine, corn starch, wheat starch, rice starch, waxy corn starch, oat starch, cassaya starch, waxy barley, waxy rice starch, glutenous rice starch, sweet rice starch, amioca starch, potato starch, tapioca starch, oat starch, cassaya starch, derivatives thereof and combinations thereof. Highly preferred starches are pre-gelatinized starches. Most preferred starches are corn starch, waxy corn starch, potato starch, derivatives thereof and combinations thereof.

Preferred modified starches are starch hydrolyzates (hydrolysis product of starches), hydroxyalkylated starch, starch esters, cross-linked starch, starch acetates, octenyl succinated starch, oxidized starch, derivatives thereof and any combination thereof. Properties such as absorption, encapsulation, retention and release of the active ingredient can be modified by using starches with different degrees of modification. The viscoelastic properties of the particle can be modified by controlling the percent amylose/amylopectin present in the starch and the degree of gelatinization in the starch. It may be preferred that the polymeric material comprises a combination of a modified starch and a pre-gelatinized starch.

Preferably, the polymeric material comprises a polyvinyl alcohol (PVA) and/or derivatives thereof including co-polymers thereof, ter-polymers thereof, and combinations thereof.

The polymeric material preferably comprises: polyvinyl pyrrolidone (PVP) and/or derivatives thereof; hydroxy propyl methyl cellulose (HPMC) and/or derivatives thereof, cellulose ethers and/or derivatives thereof; polyacrylamide and/or derivatives thereof; polyethylene oxide and/or derivatives thereof; polyethylene imine and/or derivatives thereof; and any combination thereof. The polymeric material may comprise co-polymers of the polymers described hereinabove with one another, or with other monomers or oligomers. Preferred are PVP and/or derivatives thereof. Most preferably PVA and/or derivatives thereof; or mixtures of PVA with PVP. Most preferred may also be a polymeric material only comprising PVA. A highly preferred polymeric material is a PVA supplied by Hoechst Celanese Corp. under the trade name MOWIOL, especially preferred grades of this PVA are the 4-88 and 3-83 grades. Preferably, such polymers have a level of hydrolysis of at least 50%, more preferably at least 70% or even from 85% to 95%. A highly preferred polymeric material comprises PVA and starch. Preferably the weight ratio of PVA to starch is from 1:1 or above, or from 5:1 or above.

The polymeric material can have any weight average molecular weight, typically from about 1000 to 1,000,000, or even from 4000 to 250000 or even from 8000 to 150000 or even from 10000 to 70000 daltons. Preferred are polymeric materials having a weight average molecular weight of from 10,000 (10K) to 40,000 (40K), more preferably from 10,000 (10K) to 30,000 (30K), most preferably from 10,000 (10K) to 20,000 (20K) daltons.

The matrix may comprise cross-linking agents, to modify the properties of the matrix and the resulting particle as appropriate. Preferred cross-linking agents comprise a source of borate, including perborate.

It may be preferred that the polymer has a secondary function, for example a function in a composition wherein the particle is to be incorporated: for cleaning products, it is useful when the polymer is preferably a dye transfer inhibiting polymer, dispersant, flocculant, etc.

The polymeric material may be internally plasticized. Preferred polymeric materials are internally plasticized PVAs such as those described in Polyvinyl Alcohol Properties & Applications, 2^{nd} edition, edited by C A Finch, published by John Wiley & Sons.

If the polymeric material comprises PVA, then it may be preferred that the particle is free from a source of borate ions. This is especially true if it is preferred that the degree of cross-linking of the polymeric material is kept to a minimum.

The matrix preferably comprises a plasticizer. Most preferably the matrix comprises a polymeric material and a plasticizer. Any plasticizer which is suitable to aid the formation of a matrix as defined herein can be used. Mixtures of plasticizer may also be used. Preferably, when water is used, an additional plasticizer is present.

Preferably, the plasticizer or at least one of the plasticizers, has a boiling point above 40° C., preferably above 60° C., or even above 95° C., or even above 120° C., or even above 150° C.

Preferred plasticizers comprise: glycerol; glycol derivatives including ethylene glycol and/or propylene glycol; polyglycols; digomeric polyethylene glycols such as diethylene glycol, triethylene glycol and tetraethylene glycol; polyethylene glycol with a weight average molecular weight of less than 1000; wax and derivatives thereof including carbowax; ethanolacetamide; ethanolformamide; triethanolamine and/or derivatives thereof including acetate derivatives thereof and ethanolamine salt derivatives thereof; sodium thiocyanates; ammonium thiocyanates; polyols including 1,3-butanediol; sugars, including hydroxy propyl sucrose; sugar alcohols; sorbitol; sulphonated oils; ureas; dibutyl and/or dimethyl pthalate; oxa monoacids; oxa diacids; diglycolic acids and derivatives thereof including other linear carboxylic acids with at least one ether group distributed along the chain; water; or any combination thereof.

If the polymeric material comprises polyvinyl alcohol, then preferred plasticizers are water-soluble organic compounds comprising hydroxy, amide and/or amino groups. Highly preferred plasticizers are water, ethylene glycol, trimethylene glycol, tetramethylene glycol, pentamethylene glycol, hexamethylene glycol, propylene glycol, glycerol, 2,3-butane diol, 1,2-butane diol, diethylene glycol, triethylene glycol, tetraethylene glycol, nonaethylene glycol derivatives thereof, ethanol acetamide, ethanol formamide, ethanol amine salts, urea-formaldehyde, phenol-formaldehyde, and any combination thereof.

If the polymeric material comprises a starch, then preferred plasticizers glycerol, sorbitol, mannitol, sucrose, maltose, glucose, urea, derivatives thereof, and any combination thereof. Other preferred plasticizers are nonionic surfactants.

The plasticizer is preferably present at a level of at least 0.5% by weight of the particle or more preferably by weight of the matrix, provided that when water is the only plasticizer it is present at a level of above 2%, preferably at least 3% by weight of the particle, or more preferably by weight of the matrix. Preferably, the plasticizer is present at a level of from 1% to 60% by weight of the particle or matrix, more preferably from 2%, or from 3%, or from 4%, or from 5%, or from 6%, or from 7%, or from 8% by weight of the particle or matrix, and preferably to 50%, or to 40%, or to 25%, or to 15% or to 12% by weight of the particle or matrix. The exact level will depend on the polymeric material and plasticizer used, and is preferably such that the matrix has the desired properties which result in the particle being resistant to dust generation, this is described in more detail hereinafter. For example, when glycerol or ethylene glycol or other glycol derivatives with a number average molecular weight of from 200 to about 1500 grams/mole are used, higher levels may be preferred, for example 2% to 30% by weight of the particle or matrix.

The weight ratio of polymeric material to plasticizer in the matrix is preferably from 1:1 to 100:1, more preferably from 1:1 to 70:1, or from 1:1 to 50:1, more preferably from 1:1 to 30:1, or even from 1:1 to 20:1, again depending on the type of plasticizer and polymeric material used. For example, when the polymeric material comprises PVA and the plasticizer comprises glycerol and/or derivatives and optionally water, the ratio is preferably around 15:1 to 8:1, a preferred ratio being around 10:1.

The matrix is preferably viscoelastic, having similar or the same viscoelasticity and storage modulus, relative density, and/or flexible properties as described hereinabove for the particle.

The properties of the matrix, in particular of any polymeric materials and/or plasticizers comprised therein, can be modified to alter the storage modulus of the matrix and/or particle: a rigid matrix comprising a rigid polymeric material with a high storage modulus (E^{components}), can be made into a flexible matrix by adjusting the levels and/or type of plasticizer, and optionally by modifying the relative density of the particle (for example by introducing gas into the matrix).

Depending on the required properties of the particle and/or matrix, the polymeric material can be adjusted or modified. For example: to reduce the solubility of the particle, polymeric material may be included in the particle, which has a high weight average molecular weight, typically above 50000 or even above 100000, and vice-versa; to change the solubility of the particle. If the polymeric material comprises PVA, then the solubility of polymeric material can be altered by varying level of hydrolysis of the PVA.

Active Ingredient

The active ingredient can be any material which is to be delivered to a liquid environment, or preferably an aqueous environment and preferably an ingredient which is active in an aqueous environment. For example, when used in cleaning compositions the active ingredient can be any active cleaning ingredient.

In particular, it is beneficial to incorporate in the particle, active ingredients which are moisture sensitive or react upon contact with moisture, or solid ingredients which have a limited impact robustness and tend to form dust during handling. The active ingredient is typically a moisture sensitive ingredient, a temperature sensitive ingredient, an oxidizeable ingredient, a volatile ingredient, or a combination thereof. The active ingredient may be biological viable material, hazardous and/or toxic material, an agricultural ingredient such as an agrochemical, a pharmaceutical ingredient such as a medicine or drug, or a cleaning ingredient. The active ingredient preferably comprises enzymes, perfumes, bleaches, bleach activators, bleach catalysts, dye transfer inhibitors, fabric softeners, fabric conditioners, surfactants such as liquid nonionic surfactant, conditioners, antibacterial agents, effervescence sources, brighteners, photo-bleaches and any combination thereof.

A highly preferred active ingredient comprises one or more enzymes, preferably a detergent enzyme, i.e. an enzyme suitable for a detergent composition; as described in details herein below.

The active ingredient is generally incorporated in the particle of the present invention at a level of from 0.1% to 55%, preferably from 0.5% to 35% active ingredient by weight of the particle. If the active ingredient is an enzyme, this level is expressed in % pure enzyme by weight of the particle.

A highly preferred active ingredient comprises one or more enzymes. Preferred enzymes are those used in cleaning, textile treatment, corn refining, pharmaceutical compositions, cosmetic applications and other industrial applications.

Suitable enzymes include enzymes selected from peroxidases, proteases, glucoamylases, amylases, xylanases, cellulases, lipases, phospholipases, esterases, cutinases, pectin degrading enzymes, keratanases, keratinases, reductases, oxidases, phenoloxidases, lipoxygenases, ligninases, pullulanases, tannases, pentosanases, malanases, B-glucanases, arabinosidases, hyaluronidase, chondroitinase, dextranase, transferase, laccase, mannanase, xyloglucanases, or mixtures thereof. Detergent compositions generally comprise a cocktail of conventional applicable enzymes like protease, amylase, cellulase, lipase.

Protease

Suitable proteases are the subtilisins which are obtained from particular strains of B. subtilis, B. licheniformis and B. amyloliquefaciens (subtilisin BPN and BPN′), B. alcalophilus and B. lentus. Suitable Bacillus protease is ESPERASE® with maximum activity at pH 8-12, sold by Novozymes and described with its analogues in GB 1,243,784. Other suitable proteases include Alcalase®, Everlase, Durazym® and Savinase® from Novozymes and Properase® and Purafect Ox® from Genencor. Proteolytic enzymes also encompass modified bacterial serine proteases, such as those described in EP 251 446 (particularly pages 17, 24 and 98) referred to as “Protease B”, and in EP 199 404 which refers to a modified enzyme called “Protease A” herein. Also suitable is the “Protease C”, which is a variant of an alkaline serine protease from Bacillus in which lysine replaced arginine at position 27, tyrosine replaced valine at position 104, serine replaced asparagine at position 123, and alanine replaced threonine at position 274; and is described in WO 91/06637. Genetically modified variants, particularly of Protease C, are also included herein.

A preferred protease referred to as “Protease D” is a carbonyl hydrolase variant having an amino acid sequence not found in nature, which is derived from a precursor carbonyl hydrolase by substituting a different amino acid for a plurality of amino acid residues at a position in said carbonyl hydrolase equivalent to position +76, preferably also in combination with one or more amino acid residue positions equivalent to those selected from the group consisting of +99, +101, +103, +104, +107, +123, +27, +105, +109, +126, +128, +135, +156, +166, +195, +197, +204, +206, +210, +216, +217, +218, +222, +260, +265, and/or +274 according to the numbering of Bacillus amyloliquefaciens subtilisin, as described in WO95/10591 and in WO95/10592. Also suitable is a carbonyl hydrolase variant of the protease described in WO95/10591, having an amino acid sequence derived by replacement of a plurality of amino acid residues replaced in the precursor enzyme corresponding to position +210 in combination with one or more of the following residues: +33, +62, +67, +76, +100, +101, +103, +104, +107, +128, +129, +130, +132, +135, +156, +158, +164, +166, +167, +170, +209, +215, +217, +218, and +222, where the numbered position corresponds to naturally-occurring subtilisin from Bacillus amyloliquefaciens or to equivalent amino acid residues in other carbonyl hydrolases or subtilisins, such as Bacillus lentus subtilisin (WO98/55634).

Also preferred proteases are multiply-substituted protease variants. These protease variants comprise a substitution of an amino acid residue with another naturally occurring amino acid residue at an amino acid residue position corresponding to position 103 of Bacillus amyloliquefaciens subtilisin in combination with a substitution of an amino acid residue positions corresponding to positions 1, 3, 4, 8, 9, 10, 12, 13, 16, 17, 18, 19, 20, 21, 22, 24, 27, 33, 37, 38, 42, 43, 48, 55, 57, 58, 61, 62, 68, 72, 75, 76, 77, 78, 79, 86, 87, 89, 97, 98, 99, 101, 102, 104, 106, 107, 109, 111, 114, 116, 117, 119, 121, 123, 126, 128, 130, 131, 133, 134, 137, 140, 141, 142, 146, 147, 158, 159, 160, 166, 167, 170, 173, 174, 177, 181, 182, 183, 184, 185, 188, 192, 194, 198, 203, 204, 205, 206, 209, 210, 211, 212, 213, 214, 215, 216, 217, 218, 222, 224, 227, 228, 230, 232, 236, 237, 238, 240, 242, 243, 244, 245, 246, 247, 248, 249, 251, 252, 253, 254, 255, 256, 257, 258, 259, 260, 261, 262, 263, 265, 268, 269, 270, 271, 272, 274 and 275 of Bacillus amyloliquefaciens subtilisin; wherein when said protease variant includes a substitution of amino acid residues at positions corresponding to positions 103 and 76, there is also a substitution of an amino acid residue at one or more amino acid residue positions other than amino acid residue positions corresponding to positions 27, 99, 101, 104, 107, 109, 123, 128, 166, 204, 206, 210, 216, 217, 218, 222, 260, 265 or 274 of Bacillus amyloliquefaciens subtilisin and/or multiply-substituted protease variants comprising a substitution of an amino acid residue with another naturally occurring amino acid residue at one or more amino acid residue positions corresponding to positions 62, 212, 230, 232, 252 and 257 of Bacillus amyloliquefaciens subtilisin as described in WO99/20723, WO99/20726, WO99/20727, WO99/20769, WO99/20770 and WO99/20771 (The Procter & Gamble and/or Genencor). Preferred multiply substituted protease variants have the amino acid substitution set 101/103/104/159/232/236/245/248/252, more preferably 101 G/103A/1041/159D/232V/236H/245R/248D/252K according to the BPN′ numbering.

Also suitable for the present invention are proteases described in patent applications EP 251 446 and WO 91/06637, protease BLAP® described in WO91/02792 and their variants described in e.g. WO 95/23221, DE 19857543.

Current protein engineering technologies allow selecting and developing optimized proteolytic enzymes with better compatibility with the product matrix, application conditions and/or which demonstrate high specificity towards performance relevant parameters. In this context, the following enzymes have been developed and are suitable for the compositions of the present invention: Alkaline proteases such as described e.g. in WO 00/61769 (Cheil Co), JP 200060547 (Toto), JP11228992 (KAO), Bacillus sp. NCIMB 40338 described in WO 93/18140 (Novozymes); Acidic proteases such as those described in WO99/50380 (Novozymes); Psychrophylic protease as for example in WO 99/25848 (Procter & Gamble); Thermostable proteases, such as described in. WO 9856926 (Takara]); Proteases showing keratin hydrolyzing activity or blood or grass stain removal have also been developed such as those in. EP 1 036 840 (KAO), U.S. Pat. No. 6,099,588 (Novozymes), WO00/05352 (Procter & Gamble), WO 99/37323 (Genencor), U.S. Pat. No. 5,877,000 (Burtt); Proteases having reduced allergenicity, e.g. WO99/53078 (Genencor), WO99/48918 and WO99/49056 (Procter & Gamble); Several proteases having increased specific activity or showing improved robustness versus other detergent ingredients like surfactant, bleach, chelants, etc. have been developed and are described in the patent literature; and Proteases showing fabric care benefits.

Further suitable are metalloproteases such as those described in e.g. WO99/33959, WO99/33960, WO99/34001, WO99/34002, WO99/34003 all by Genencor and proteases described in e.g. the published application from WO00/03721 to WO00/03727. See also a high pH protease from Bacillus sp. NCIMB 40338 described in WO 93/18140 (Novozyme).

Enzymatic detergents comprising protease, one or more other enzymes, and a reversible protease inhibitor are described in WO92/03529 A to Novo. When desired, a protease having decreased adsorption and increased hydrolysis is available as described in WO95/07791 to Procter & Gamble. A recombinant trypsin-like protease for detergents suitable herein is described in WO 94/25583 to Novo. Unilever describes other suitable proteases in EP 516 200.

Amylase

Amylases (α and/or B) can be included for removal of carbohydrate-based stains. WO94/02597 (Novozymes) describes cleaning compositions that incorporate mutant amylases. See also WO95/10603 (Novozymes). Other amylases known for use in cleaning compositions include both α- and β-amylases. α-Amylases are known in the art and include those disclosed in U.S. Pat. No. 5,003,257; EP 252 666; WO91/00353; FR 2,676,456; EP 285 123; EP 525 610; EP 368 341; and GB 1,296,839. Other suitable amylases are stability-enhanced amylases described in WO94/18314 and WO96/05295, Genencor and amylase variants having additional modification in the immediate parent available from Novozymes disclosed in WO 95/10603. Also suitable are amylases described in EP 277 216, WO95/26397 and WO96/23873 (all by Novozymes Nordisk).

Examples of commercial α-amylases products are Purafect Ox Am® from Genencor and Natalase®, Termamyl®, Ban®, Fungamyl® and Duramyl®, all available from Novozymes. WO95/26397 describes other suitable amylases: α-amylases characterized by having a specific activity at least 25% higher than the specific activity of Termamyl® at a temperature range of 25° C. to 55° C. and at a pH value in the range of 8 to 10, measured by the Phadebas® α-amylase activity assay. Suitable are variants of the above enzymes, described in WO96/23873 Novozymes. Preferred variants therein are those with increased thermostability described on p16 of WO96/23873, and especially the D183*+G184* variant.

Current protein engineering technologies allow selecting and developing optimized amylases with better compatibility with the product matrix, application conditions and/or which demonstrate high specificity towards performance relevant parameters. In this context, the following enzymes have been developed and are suitable for the compositions of the present invention: Alkaline amylases such as described e.g. in EP 1 022 334, JP2000023665, JP2000023666, and JP2000023667 (all by KAO), JP 2000060546 (Toto), WO00/60058 (Novozymes); Acidic amylases such as in FR 2778412 (University Reims); Psychrophylic amylases; Amylases with improved thermostability, such as in e.g. WO99/02702 (Genencor); Amylases having reduced allergenicity; Amylases having increased specific activity or showing improved robustness versus other detergent ingredients like surfactant, bleach, chelants, etc. are useful and can be found in the patent literature, e.g as described in WO95/35382; and Amylases delivering fabric care benefits.

Also suitable are the following starch degrading enzymes:

Suitable Cyclomaltodextrin glucanotransferase “CGTase” (E.C. 2.4.1.19) are the CGTase described in WO96/33267, WO99/15633 and WO99/43793. More preferred are the CGTase variants of WO99/15633 showing an increased product specificity with respect to the production of β-cyclodextrin. Commercially available CGT-ases are the products sold under the tradenames Toruzyme by NovoZyme.

Suitable maltogenic alpha amylase (EC 3.2.1.133) are described in EP 120 693, WO99/43794 and WO99/43793. Preferred are the Novamyl enzyme described in EP 120 693; the Novamyl variant A (191-195)-F188L-T189Y (See example 4 of WO99/43793); and the variants of Novamyl A191-195 and F188L/T189Y/T142A/N327S (See example 5 of WO99/43794). Novamyl is commercially available from NovoZyme.

Beta-amylase EC 3.2.1.2, are also suitable. These 1,4-α-D-glucan maltohydrolases provide exohydrolysis of 1,4-α-D-glucosidic linkages in polysaccharides to remove successive maltose units from non-reducing ends of the chain.

Suitable amyloglucosidases EC 3.2.1.3. are described in WO92/00381, WO98/06805, WO99/28448 and WO0/04136 (All by NovoZyme). Commercially available amyloglucosidases are the enzyme products sold under the trademane PALKODEX by MAPS; AMG300L by Novo Nordisk A/S, Optimax 7525 (Combinations of enzymes including amyloglucosidase) and Spezyme by Genencor.

Cellulase

Suitable cellulases include both bacterial and fungal cellulases. Preferably, they will have a pH optimum of between 5 and 12 and a specific activity above 50 CEVU/mg (Cellulose Viscosity Unit). Suitable cellulases are disclosed in U.S. Pat. No. 4,435,307, J61078384 and WO96/02653 which discloses fungal cellulase produced respectively from Humicola insolens, Trichoderma, Thielavia and Sporotrichum. EP 739 982 describes cellulases isolated from novel Bacillus species. Suitable cellulases are also disclosed in GB-A-2.075.028; GB-A-2.095.275; DE-OS-2.247.832 and WO95/26398.

Further examples of such cellulases are cellulases produced by a strain of Humicola insolens (Humicola grisea var. thermoidea), particularly the Humicola strain DSM 1800. Other suitable cellulases are cellulases originated from Humicola insolens having a molecular weight of about 50 KDa, an isoelectric point of 5.5 and containing 415 amino acids; and a ^{˜}43 kD endoglucanase derived from Humicola insolens, DSM 1800, exhibiting cellulase activity; a preferred endoglucanase component has the amino acid sequence disclosed in WO 91/17243. Also suitable cellulases are the EGIII cellulases from Trichoderma longibrachiatum described in WO94/21801 (Genencor). Especially suitable cellulases are the cellulases having color care benefits such as the cellulases described in EP 495 257. Carezyme® and Celluzyme® (Novozymes) are especially usefu. Other suitable cellulases for fabric care and/or cleaning properties are described in WO96/34092, WO96/17994, WO91/17244, WO91/21801 and WO95/24471. More suitable cellulases are described in e.g. EP 921 188 (Clariant), WO00/14206 and WO00/14208 (both Genencor), U.S. Pat. No. 5,925,749 and U.S. Pat. No. 6,008,032 (both Diversa).

Current protein engineering technologies allow selecting and developing optimized cellulolytic enzymes with better compatibility with the product matrix, application conditions and/or which demonstrate high specificity towards performance relevant parameters. In this context, the following enzymes have been developed and are suitable for the compositions of the present invention : Alkaline cellulases such as described e.g. in JP10313859 and JP 20000160194 (both KAO), Acidic cellulases, Psychrophylic cellulases, Cellulases with improved thermostability, e.g. JP2000210081 (KAO); Cellulases having reduced allergenicity; Cellulases having increased specific activity or showing improved robustness versus other detergent ingredients like surfactant, bleach, chelants, etc. are useful and can be found in the patent literature.

Most cellulases do comprise a cellulose binding domain (CBD). Those cellulose binding domains have been used to deliver performance. Indeed, CDB's can be used as such or can act as a vehicle to drive active agents to the cellulose substrate. Examples are given in WO00/18864, WO00/18897 and WO00/18898 (all by Procter & Gamble).

Lipase

Other enzymes that can be included in the detergent compositions of the present invention include lipases. Suitable lipase enzymes for detergent usage include those produced by the Pseudomonas group, such as Pseudomonas stutzeri ATCC 19.154 (GB 1,372,034). Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such as produced by Pseudomonas pseudoalcaligenes (EP 218 272) or variants thereof (WO9425578) previously supplied by Gist-Brocades as M1 Lipase^{R} and Lipomax^{R} or Lipolase^{R} and Lipolase Ultra^{R} (Novozymes) which have found to be very effective when used in combination with the compositions of the present invention. Also suitable are the lipolytic enzymes described in EP 258 068, EP 943678, WO92/05249, WO95/22615, WO99/42566, WO00/60063 (all by Novozymes) and in WO94/03578, WO95/35381 and WO96/00292 (all by Unilever).

Also suitable are cutinases [EC 3.1.1.50] that can be considered as a special kind of lipase, namely lipases which do not require interfacial activation. Addition of cutinases to detergent compositions have been described in e.g. WO88/09367 (Genencor); WO90/09446 (Plant Genetic System) and WO94/14963 and WO94/14964 (Unilever), WO0/344560 (Novozymes)

Current protein engineering technologies allow selecting and developing optimized cellulolytic enzymes with better compatibility with the product matrix, application conditions and/or which demonstrate high specificity towards performance relevant parameters. In this context, the following enzymes have been developed and are suitable for the compositions of the present invention : Alkaline lipases such as described e.g. in JP2000060544 (Toto); Acidic lipases; Psychrophylic lipases; Lipases with improved thermostability;

Lipases having reduced allergenicity; Lipases delivering fabric care such as e.g. in WO99/01604 by Novozymes and Lipases having increased specific activity or showing improved robustness versus other detergent ingredients like surfactant, bleach, chelants, etc. are useful and can be found in the patent literature, e.g. WO96/00292 [Unilever]

Carbohydrase

Also suitable in detergent compositions are the following carbohydrases:

Mannanase (E.C. 3.2.1.78). Preferably, the mannanase will be an alkaline mannanase selected from the mannanase from the strain Bacillus agaradhaerens NICMB 40482; the mannanase from Bacillus sp. 1633; the mannanase from Bacillus sp. AAI12; the mannanase from the strain Bacillus halodurans (all described in WO99/64619) and/or the mannanase from Bacillus subtilis strain 168, gene yght described in U.S. Pat. No. 6,060,299; most preferably the one originating from Bacillus sp. 1633.

Suitable are pectin degrading enzymes : protopectinase, polygalacturonase, pectin lyase, pectin esterase and pectate lyase (described in WO95/25790, WO98/0686, WO98/0687, WO99/27083 and WO99/27083). Preferred are the pectate lyase (EC.4.2.2.2). Suitable pectate lyase are described in WO99/27084, WO00/55309 and WO00/75344 from Novozyme.

Xyloglucanase are enzymes exhibiting endoglucanase activity specific for xyloglucan. Those enzymes hydrolyze 1,4-β-D-glycosidic linkages present in any cellulosic material. The endoglucanase activity may be determined such as in WO 94/14953. Suitable xyloglucanase are described in WO99/02663, WO01/12794 (Both Novozymes) and WO98/50513 (P&G).

Bleaching Enzymes

Bleaching enzymes are enzymes herein contemplated for bleaching and sanitisation properties. Examples of such enzymes are oxidases, dioxygenase and peroxidases. Suitable enzymes are disclosed in EP-A-495 835 (Novozymes). Also suitable are bleaching enzymes of Coprinus strains (WO 98/10060) or Laccases of Myceliophtera strains (WO 98/27197) used with enhancing agents such as substituted phenothiazine or alkylsyringate (WO 97/11217; U.S. Pat. No. 5,795,855). Other preferred enzymes are oxygenases (E.C. 1.13 and E.C 1.14) such as catechol 1,2 dioxygenase (WO 99/02639) and lipoxygenase (WO 95/26393). Also included are the haloperoxidases of Curvularia species (WO 97/04102) and non-heme haloperoxidase of Serratia (WO 99/02640).

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimize their performance efficiency in the detergent compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application. In regard of enzyme stability detergents, attention should be focused on amino acids sensitive to oxidation in the case of bleach stability and on surface charges for the surfactant compatibility. The isoelectric point of such enzymes may be modified by the substitution of some charged amino acids. The stability of the enzymes may be further enhanced by the creation of e.g. additional salt bridges and enforcing metal binding sites to increase chelant stability. Furthermore, enzymes might be chemically or enzymatically modified, e.g. PEG-ylation, cross-linking and/or can be immobilized, i.e. enzymes attached to a carrier can be applied.

The enzyme to be incorporated in the particle of the present invention, can be in any suitable form, e.g. liquid, encapsulate, prill, granulate, or any other form according to the current state of the art. For practical and economical reasons, liquid slurry or solid-liquid dispersions enzyme feedstocks are preferred.

Other preferred active ingredients comprise perhydrate bleach and photobleaches. Perhydrate bleach are for example metal perborates, metal percarbonates, particularly the sodium salts. Also, another preferred active ingredient comprises organic peroxyacid bleach precursor or activator compound, preferred are alkyl percarboxylic precursor compounds of the imide type include the N-,N,N¹N¹ tetra acetylated alkylene diamines wherein the alkylene group contains from 1 to 6 carbon atoms, particularly those compounds in which the alkylene group contains 1, 2 and 6 carbon atoms such as Tetra-acetyl ethylene diamine (TAED), sodium 3,5,5-tri-methyl hexanoyloxybenzene sulfonate (iso-NOBS), sodium nonanoyloxybenzene sulfonate (NOBS), nonamido caproyl oxy benzene sulphonate, sodium acetoxybenzene sulfonate (ABS) and pentaacetyl glucose, but also amide substituted alkyl peroxyacid precursor compounds. Photoactivated bleaching agents are for example sulfonated zinc and/or aluminium phthalocyanines. These materials can be deposited upon the substrate during the washing process. Upon irradiation with light, in the presence of oxygen, such as by hanging clothes out to dry in the daylight, the sulfonated zinc phthalocyanine is activated and, consequently, the substrate is bleached. Preferred zinc phthalocyanine and a photoactivated bleaching process are described in U.S. Pat. No. 4,033,718. Typically, detergent composition will contain about 0.0001% to about 1.0%, preferably from 0.001% to 0.1% by weight, of sulfonated zinc phthalocyanine.

The active ingredient may also be in intimate contact with, or in an intimate mixture with, a material having a low hygroscopicity, for example having a hygroscopicity of 5 wt % or less, preferably 4 wt % or less, or 3 wt % or less, or 2 wt % or less, or 1 wt % or less. The values of hygroscopicity described hereinabove are the equilibrium moisture uptake of a hygroscopic material when stored in conditions of 50% relative humidity and 20° C. temperature. Preferred hygroscopic material may be a polymeric material described hereinabove, preferably: PVA; polysaccharide; polypeptide; cellulose derivatives such as methyl cellulose, hydroxy proproyl methyl cellulose, hydroxy cellulose, ethyl cellulose, carboxy methyl cellulose, hydroxy propyl cellulose; polyethylene glycol with a number average molecular weight of from about 200 to about 1500 grams/mole; polyethylene oxide; gum arabic; xanthan gum; carrageenan; chitosan; latex polymer; enteric material. In this preferred embodiment of the present invention, the active ingredient may be obtained by a micro-encapsulation process step such as a liquid-liquid emulsion process step, this is described in more detail hereinafter.

Adjunct Ingredients

The particle may comprise adjunct ingredients. These adjunct ingredients are in addition to the active ingredient.

Preferred adjunct ingredients are process aids, stabilizers, lubricant, dispensing aids, pH regulators, solubilisers including hydrotropes and disintegrating aids, densification aids, dyes, whitening agents, fillers, antioxidants, scavengers such as chlorine scavengers, and any combination thereof.

Other preferred adjunct ingredients are effervescence sources, in particular those based on organic carboxylic acids and/or mixtures thereof, and salts (sodium) of percarbonate and/or carbonate sources. Preferred are citric acid, malic acid, maleic acid, fumaric acid carbonate and/or bicarbonate, derivatives thereof including salts thereof, and any combination thereof. These may for example be comprised in the matrix. It has been found that in particular the presence of an acidic material improves the dissolution and/or dispersion of the particle upon contact with water, and can also reduce or prevent interactions, leading to for example precipitation, of the polymeric material (if present), with cationic species (if present), in the aqueous medium.

Preferred may also be to incorporate, preferably in the polymeric material if present, disintegrating polymers or water-swellable polymers, which aid dissolution of the particle. Thus, these may form part of the matrix herein. Examples of such aids are described in European Patents 851025-A and 466484-A.

Preferred adjunct ingredients are chelating agents such as ethylene di-amine di-succinic acid (EDDS), diethylene triamine penta (methylene phosphonic acid) (DTPMP) and ethylene diamine tetra(methylene phosphonic acid) (DDTMP).

Preferred adjunct ingredients are inorganic salts or silicates, including zeolites and/or phosphates. Other preferred adjunct ingredients are ammonium compounds such as ammonium sulfate, ammonium citrate, granular urea, guanidine hydrochloride, guanidine carbonate, guanidine sulfonate, granular thiourea dioxide, and combinations thereof.

Coloring agents such as iron oxides and hydroxides, azo-dyes, natural dyes, may also be preferred, preferably present at levels of 0.001% and 10% or even 0.01 to 5% or even 0.05 to 1% by weight of the particle. Preferably the particle of the present invention comprises whitening agent such as Titanium Dioxide.

Highly preferred may be that the particle is coated, or at least partially coated with a coating material. Preferred may be coating agents containing a polymeric material. The coating material further protects the particle from dust generation and further stabilizes the particle and the active ingredient therein.

Preferably, if the matrix comprises a polymeric material, then the coating material comprises the same type of polymeric material that is comprised by the matrix. Another preferred coating material is an antioxidant as described below. Preferably such antioxidant has a particle size below 100 μm and more preferably below 50 μm to provide a more uniform coating. It has been found that coating the particle in such a manner will ensure a high Kc of the particle, and maintain or even enhance the particles resistance to dust generation. This is especially true for particles comprising a polymeric material. The coating material preferably comprises a plasticizer. Suitable plasticizers are those described hereinabove for the matrix. Preferably, the coating material is free from active ingredient. Alternatively, the coating material may also enclose, or at least partially enclose, the active ingredient.

The coating material is typically contacted to the active ingredient to form a coat on the active ingredient prior to the active ingredient being contacted to the matrix.

Highly preferred is that the particle comprise (as pH-controller or dissolution aid) an acid such as citric acid, acetic acid, acetic acid glacial, formic acid, fumaric acid, hydrochloric acid, malic acid, maleic acid, tartaric acid, nitric acid, phosphoric acid, sulfuric acid, pelargonic acid, lauric acid, and derivatives thereof including salts thereof, or any combination thereof. The particle may comprise buffering agents which comprise boric acid, sodium acetate, sodium citrate, acetic acid, potassium phosphates, derivatives thereof and any combination thereof.

The component of the invention preferably comprises adjunct ingredients which can improve the dissolution properties of the particle herein. Preferred adjunct ingredients which improve the dissolution of the particle herein include: sulfonated compounds such as C₁-C₄ alk(en)yl sulfonates; C₁-C₄ aryl sulfonates; di iso butyl benzene sulphonate; toluene sulfonate; cumene sulfonate; xylene sulfonate; derivatives thereof including salts thereof such as sodium salts thereof; or combinations thereof. Preferred are: di iso butyl benzene sulphonate; sodium toluene sulfonate; sodium cumene sulfonate; sodium xylene sulfonate and combinations thereof.

Other adjunct ingredients which are capable of acting as wicking agents may be preferred: cellulosic based ingredients especially modified cellulose; and/or swelling agents such as clays, preferred clays are smectite clays, especially dioctahedral or trioctrahedral smectite clays, highly preferred clays are montmorillonite clay and hectorite clay, or other clays found in bentonite clay formations; and/or effervescence systems.

The particle preferably comprises adjunct ingredients which can improve the stability of the active ingredient. These adjunct ingredients are typically capable of stabilizing the active ingredient, this is especially preferred when the active ingredient(s) comprise an oxidative or moisture sensitive active ingredient, such as one or more enzymes. These adjunct ingredients may also stabilize the matrix and/or particle, and thus indirectly stabilize the active ingredient. These adjunct ingredients preferably stabilize the active ingredient, matrix and/or particle from oxidative and/or moisture degradation.

Preferably these stabilizing adjunct ingredients are surfactants such as: a fatty alcohol; fatty acid; alkanolamide; amine oxide; betaine, sodium alky(en)yl sulfonates; sodium alkoxysulfonates; sodium dodecyl sulphate; TEA cocoyl glutamate, Decyl Glucoside, Sodium Lauryl Suphate, Potassium laurylphosphate, Sodium Lauroyl Sarcosinate, lauramine oxide, Cocamidopropyl Betaine, Sodium Laureth-2 Sulfate, Sodium Laureth-3 Sulphate, Cocamidopropyl hydroxysultaine, decyl amine oxide, derivatives thereof; or any combination thereof. Preferred alkoxysulfonates are those comprising from 10 to 18 carbon atoms in any conformation, preferably linear, and having a n average ethoxylation degree of from 1 to 7, preferably from 2 to 5.

These stabilizing adjunct ingredients may comprise betaine, sulfobetaine, phosphine oxide, alkyl sulfoxide, derivatives thereof, or combinations thereof. Other preferred stabilizing adjunct ingredients comprises one or more anions or cations such as mono-, di-, tri-valent, or other multivalent metal ions, preferred are salts of sodium, calcium, magnesium, potassium, aluminium, zinc, copper, nickel, cobalt, iron, manganese and silver, preferably having an anionic counter-ion which is a sulphate, carbonate, oxide, chloride, bromide, iodide, phosphate, borate, acetate, citrate, and nitrate, and combinations thereof.

Preferred stabilizing adjunct ingredients comprise finely divided particles, preferably finely divided particles having an average particle size of less than 10 micrometers, more preferably less than 1 micrometer, even more preferably less than 0.5 micrometers, or less than 0.1 micrometers. Preferred finely divided particles are aluminosilicates such as zeolite, silica, or electrolytes described hereinbefore being in the form of finely divided particles. Preferred stabilizing adjunct ingredients may comprise agar-agar, sodium alginate, sodium dodecyl sulfate, polyethylene oxide (PEO), guar gum, polyacrylate, derivatives thereof, or combinations thereof.

Other preferred adjunct ingredients comprise small peptide chains averaging from 3 to 20 and preferably from 3 to 10 amino acids, which interact with and stabilize the active ingredient, especially enzyme(s). Other preferred adjunct ingredients comprise small nucleic acid molecules, typically comprising from 3 to 300, preferably from 10 to 100 nucleotides. Typically, the nucleic acid molecules are deoxyribonucleic acid and ribonucleic acid. The nucleic acid molecules may be in the form of a complex with other molecules such as proteins, or may form a complex with the active ingredient, especially enzyme(s).

Other highly preferred adjunct ingredients are anti-oxidants and/or reducing agents. These are especially preferred when the particle comprises a bleach or when the enzyme-containing detergent particle of the present invention is incorporated into a bleach containing detergent composition. Indeed, it has been found that antioxidants and/or reducing agent improve the long term stability of the enzyme-containing particle of the present invention. These antioxidants and/or reducing agents can be formulated within the detergent particle of the present invention and/or comprised in a coating layer. These antioxidants and/or reducing agents are herein referred to as “antioxidant”. They are generally incorporated into the particle of the present invention at a level of from 0.1% to 15%, preferably 5% to 12% by weight of the particle. Suitable antioxidants are alkali metal salts and alkaline earth metal salts of boric acid, sulfurous acid, thiosulfuric acid; especially sodium tetraborate, sodium sulfite, sodium thiosulfate; and ascorbic acid, sodium ascorbate, erythorbic acid, sodium erythorbate,dl-α-tocopherol, isopropyl citrate, butylated hydroxytoluene (BHT), butylated hydroxyanisol (BHA), tannic acid and sulfur-containing antioxidant. Also suitable are: thiosulphate, methionine, urea, thiourea dioxide, guanidine hydrochloride, guanidine carbonate, guanidine sulfamate, monoethanolamine, diethanolamine, triethanolamine, amino acids such as glycine, sodium glutamate, proteins such as bovine serum albumin and casein, tert-butylhydroxytoluene, 4-4,-butylidenebis (6-tert-butyl-3-methyl-phenol), 2,2′-butlidenebis (6-tert-butyl-4-methylphenol), (monostyrenated cresol, distyrenated cresol, monostyrenated phenol, distyrenated phenol, 1,1-bis (4-hydroxy-phenyl) cyclohexane, or derivatives thereof, or a combination thereof. Preferred antioxidants are sodium thiosulfate, sodium sulfite, BHT, ascorbic acid and sodium ascorbate, more preferred is sodium thiosulfate.

Other adjunct ingredients may comprise a reversible inhibitor of the active ingredient. Without wishing to be bound by theory, it is believe that a reversible inhibitor of the active ingredient, especially if the active ingredient comprises one or more enzymes, may form a complex with, and improve the stability of, the active ingredient. Thus, stabilizing the active ingredient during storage. When the active ingredient is released, typically into a liquid environment, the reversible inhibitor dissociates from the active ingredient, and the active ingredient is then able to perform the desired action it is designed or intended to perform.

Other adjunct ingredients are sugars. Typical sugars for use herein include those selected from the group consisting of sucrose, glucose, fructose, raffinose, trehalose, lactose, maltose, derivatives thereof, and combinations thereof. Preferred adjunct ingredients may also comprise sugar alcohols such as sorbitol, mannitol, inositol, derivatives thereof, and combinations thereof. Preferably the weight ratio of active ingredient to sugar is from 100:1 to 1:1. In a preferred embodiment of the present invention the sugar is in an intimate mixture with the active ingredient. This is especially preferred when the active ingredient comprises a protein, especially an enzyme.

Composition

The particle may be incorporated into any composition which requires active ingredients to be protected against moisture during storage, against chemical reactions with other ingredients, migration or phase separation of ingredients, or protection against physical forces. In particular, the particle may be incorporated in cleaning compositions, fabric care compositions, personal care compositions, cosmetic compositions, pharmaceutical compositions, agrochemical compositions, diaper compositions. These compositions are typically solid, although the particle may be incorporated in a high ionic strength liquid composition. The composition may comprise any additional ingredients, including additional amounts of the active ingredients and/or polymeric materials described hereinabove. The composition may also comprise adjunct ingredients, as described hereinabove.

Preferred are laundry and dishwashing detergent compositions and fabric conditioners and other rinse aids. The cleaning compositions typically contain one or more components selected from surfactants, effervescence sources, bleach catalysts, chelating agents, bleach stabilizers, alkalinity systems, builders, phosphate-containing builders, organic polymeric compounds, enzymes, suds suppressors, lime soap, dispersants, soil suspension and anti-redeposition agents, soil releasing agents, perfumes, dyes, dyed speckles, brighteners, photobleaching agents and additional corrosion inhibitors. Preferably, the particles of the present invention will be included in solid detergent compositions such as granular, powder, tablets, etc.

For laundry detergent compositions and fabric care compositions, it may be preferred that the particle preferably comprise at least one or more softening agents, such as quaternary ammonium compounds and/or softening clays, and preferably additional agent such as anti-wrinkling aids, perfumes, chelants, fabric integrity polymers.

For personal-care products, it may be highly preferred to include cationic organic compounds, such as cationic surfactants. It can be preferred that the compositions comprise one or more other ingredient which can reduce dermatitis or compounds which can help the healing of the skin, metal-containing compounds, in particular zinc-containing compounds, vitamins and cortisone's, and also compounds to soften the skin such as vaseline, glycerin, triethyleneglycol, lanolin, paraffin and another group of polymers extensively employed by pharmaceutical and cosmetic manufactures, as also described herein.

The pharmaceutical compositions, cosmetic compositions and personal care compositions can be of any form and purpose. Preferred are pharmaceutical powders and tablets. The particle can also be incorporated in absorbing articles, for example to release the active ingredient to the skin whereto the absorbing articles is applied, when in contact with water, such as body fluids, for example diapers, wipes, catamenials, plaster, bandages.

Process of Preparation

The particle is obtained by a process in which, the matrix and an active ingredient and optionally adjunct ingredients are mixed together to form a mixture, and then forming the mixture into particles, with the proviso that the process does not comprise a freeze-drying step. The mixture may be formed into the particles by an extrusion process, a liquid/liquid emulsion process, a fluid bed process, precipitation, rotary atomization, agglomerization, or a molding process. Preferably, the particles are formed by an extrusion process. The extrusion process provides a simple, fast, efficient, cost-effective means of preparing the particle, especially when the particle is in the form of a foam.

The process preferably comprises the steps of mixing the active ingredient or part thereof, and the matrix or part thereof, to form a mixture. The mixture is then preferably extruded through an aperture onto a receiving surface, to form a particle. The particle is then preferably dried. The particle is typically released from the receiving surface. Optionally, gas is deliberately introduced into the mixture and/or particle. The gas may be introduced at any stage of the process.

A preferred process comprises the steps of mixing the active ingredient or part thereof, and the matrix or part thereof, to form a mixture. The mixture is then extruded through an aperture, preferably in a bed of powdered dusting agent to reduce stickiness, to form a noodle. The noodle is then preferably dried and is subsequently cut down to sized and sieved to achieve their required particle size and particle size distribution. Cutting techniques can include high speed cutters, grinders or spheronization steps. Preferably, the particles are coated with a polymeric coating agent using standard fluid bed coating techniques. The composition of such polymeric coating agent is typically similar to the matrix compositions. Preferably, the particles are finally dusted with a dusting agent that can optionally be antioxidant agent. Such antioxidant can also be added in an additional coating layer. Optionally, gas is deliberately introduced into the mixture and/or particle. The gas may be introduced at any stage of the process.

A more preferred process comprises the steps of mixing the active ingredient or part thereof, and the matrix or part thereof, to form a mixture. A gas is deliberately introduced into the mixture. The mixture is extruded through an aperture to form noodles of the mixture. The noodles are immediately dusted with dusting agent. The noodles are dried using standard convective air drying and/or other drying techniques. The resulting dehydrated noodle is cut down to size using standard cutting devices such as high intensity shear cutters. The resulting particles are screened to the required particle size and required particle size distribution. The particles are coated with a polymeric material of similar type to the matrix using standard coating devices such as fluid bed coating techniques. The particles are immediately dusted with antioxidant while the particles are slightly sticky so the dusting agent remains on the particle surface.

Mixture

The mixture typically comprises the active ingredient and the matrix. The mixture is preferably a fluid or liquid. The mixture typically has a viscosity of from 1 mPa.s to 200000 mPa.s. Typically the viscosity of the mixture is from 1000 mPa.s, or from 5000 mPa.s, or from 10000 mPa.s, and typically to 150000 mPa.s, or to 100000 mPa.s, or to 50000 mPa.s, or to 40000 mPa.s, when measured at a shear rate of from 1 s⁻¹ to 2000 s⁻¹ at a 25° C. temperature. Preferably, the mixture has a viscosity of ≧1000 mPa.s, more preferably ≧3000 mPa.s, most preferably from 10000 mPa.s to 75000 mPa.s. The values of viscosity described hereinabove are of the mixture as it is being extruded through the aperture.

The viscosity of the mixture depends on the chemical and physical properties of the ingredients in the mixture, which typically depends on the ingredients required in the particle. However, if the viscosity is too low, then the mixture will pour too rapidly through the aperture onto the receiving surface and will not form particles. Conversely, if the mixture is too viscous, then the mixture will either not be able to pass through the aperture, or will form noodles, as opposed to extruded particles, which will require additional cutting steps and possibly spheronization steps before a particle is obtained.

The mixture typically comprises all or most of the ingredients that will be present in the particle. Typically, the mixture comprises a polymeric material, a plasticizer and an active ingredient, and preferably also comprises other adjunct ingredients.

The water content of the mixture affects the physical and chemical properties of the mixture. Typically, the water content of the mixture is from 0.1 wt % to 90 wt %, preferably from 20 wt % to 60 wt %. If the mixture comprises ingredients, especially active ingredients, which are sensitive to water, then it is preferred that the water content of the mixture is as low as possible, possibly being less than 5 wt %, or less than 3 wt %, or less than 1 wt %, or less than 0.1 wt %, or it may even be preferred that the mixture is free from water.

The term “water” typically means water molecules which are not bound to other compounds: free water content. For example, the term “water” typically does not include the water content of hydrated molecules such as aluminosilicate, but does include water added to the mixture: as a processing aid. Alternatively, it may be preferred for the mixture to comprise water. For example, if the mixture comprises a polymeric material, it may be preferred for water to be present in the mixture to act as a plasticizer when forming the particle. If water is present in the mixture, then preferably said water is present at a level of at least 3 wt %, or at least 5 wt %, or at least 10 wt %, or at least 20 wt % or even at least 40 wt %.

The presence of solid matter in the mixture affects the extrusion process and subsequent particle formation. The extrusion of a fluid or liquid is typically more difficult when undissolved solid matter is present therein. Furthermore, the particle formed by extruding a mixture comprising undissolved solid matter typically requires additional processing steps such as spheronization.

Therefore, preferably the mixture comprises (by weight) less than 50%, preferably less than 35%, preferably less than 15%, preferably less than 10%, preferably less than 7%, preferably less than 5%, preferably less than 3%, preferably less than 1%, preferably less than 0.1% undissolved solid matter. Most preferably, the mixture comprises no undissolved solid matter or no deliberately added undissolved solid matter. Typically, the levels of undissolved solid matter described hereinabove, refer to the amount of solid matter during the step of extruding the mixture through the aperture. It may be preferred for the mixture to comprise solid matter during the process other than during the extrusion step. If undissolved solid matter is present during the extrusion step, then preferably the solid matter is in the form of undissolved particles having a particle size which enables them to pass through the aperture: the undissolved solids preferably have a mean particle diameter of less than 100 micrometers.

In a preferred embodiment of the present invention, the active ingredient is obtained by a liquid-liquid emulsion process. The liquid-liquid emulsion typically comprises a hydrophobic phase and a hydrophilic phase. Preferably, the hydrophilic phase is in the form of a series of discontinuous liquid regions, and the hydrophobic phase is typically in the form of a continuous liquid region. Most preferably, the hydrophilic phase is in the form of liquid droplets that are dispersed in a liquid hydrophobic region.

The hydrophilic layer preferably comprises the active ingredient, preferably an enzyme, and optionally a material having a hygroscopicity of less than 5 wt %, for example a polymeric material as described hereinabove, and water. The hydrophobic phase typically comprises a hydrophobic material for example an oil such as a silicone oil, as described hereinabove. The active ingredient is preferably in an intimate mixture with, or is in close proximity to, a material having a hygroscopicity of less than 5 wt %.

The mixture is then vacuum dried, typically at a pressure of below 0.1 MPa, preferably below 0.004 MPa at a temperature preferably from 10° C. to 30° C. During the vacuum drying step, water is removed from the hydrophilic phase, which is preferably dried to form particles comprising an active ingredient. The solid active ingredient particles are separated from the liquid hydrophobic phase by any suitable means including filtration, centrifugation, decanting, sedimentation or any combination thereof. The active ingredients can then be added to the mixture.

In a highly preferred embodiment of the present invention, some of the hydrophobic material remains with the solid active ingredient particles, preferably enclosing, or at least partially enclosing the solid active ingredient. The active ingredients can then be added to the mixture.

In a preferred process where the particles are formed by extrusion, the mixture is extruded through an aperture onto a receiving surface. The mixture is typically extruded through the aperture, forming an extrudate droplet. Said droplet is typically forced onto the receiving surface by a forcing means.

The aperture typically has a mean diameter of from 50 micrometers to 10 millimeters, preferably from 100 micrometers to 1000 micrometers. The aperture is typically formed by laser cutting or by drilling depending on the size of the hole required. If it is preferred that the particle is substantially spherical, then the aperture preferably has a shape that is a square, rectangle, rhombus, triangle, oval, circle or diamond, preferably diamond. If more than one aperture is used in the present invention, then more than one type of shape of aperture may be used.

Typically, the mixture is forced by a forcing means through the aperture. The force required to extrude the mixture through the aperture depends on the size of the aperture, the temperature of said extrusion step, and the physical and chemical properties of said mixture, such as viscosity. The forcing means can comprise blowing, pushing, scraping, sucking the mixture through the aperture. The forcing means can be in the form of a solid object, such as a bar, wedge, scraper, or combination thereof, which scrapes or pushes the mixture through the aperture. The forcing means may also be a pump, which pumps the mixture through the aperture. A combination of a pump and one or more means selected from a bar, wedge or scraper may also be used. The extrusion step is preferably carried out in any commercially available extruder such as Twin-screw extruders APV MPF100 Mark II or an APV lab extruder (model MP19CH).

In one preferred embodiment of the present invention, the mixture is extruded through an aperture of a rotating extrusion plate. The mixture is typically extruded through the aperture and forms an extrudate droplet.

The extruded droplet is dusted with anhydrous dusting agent, that can be antioxidant. As the rotating extrusion plate rotates, the extruded droplet is air dried & cut from the extrusion plate. The extruded particle falls into a powdered bed of antioxidant.

Typically, the rotating extrusion plate comprises more than one aperture, preferably numerous apertures. If the rotating extrusion plate comprises more than one aperture, then the apertures may be a different size. By differing the sizes of the apertures and number of apertures having the same size, the size distribution of the particle can be controlled, and particles having a desired particle size distribution can be obtained from the process. Typically the density of apertures present on the rotating extrusion plate is typically from 0.001 mm⁻² to 400 mm⁻², or from 0.01 mm⁻², or from 0.1 mm⁻², or from 1 mm⁻², or from 5 mm⁻², or from 10 mm⁻², or from 25 mm⁻², or from 50 mm⁻², or from 100 mm⁻², and preferably to 300 mm⁻², or to 275 mm⁻² or to 250 mm⁻², or to 225 mm⁻², or to 200 mm⁻², or to 175 mm⁻², or to 150 mm⁻². Different areas of the rotating extrusion plate may have a different density of apertures present in the area. For example, smaller size apertures may be present in a higher density in one area of the rotating extrusion plate, whilst larger size apertures may be present in a lower density on a different area of the rotating extrusion plate.

The rotating extrusion plate preferably rotates at from 1 rpm to 1000 rpm, preferably from 2 rpm, or from 3 rpm, or from 4 rpm, or from 5 rpm, or from 6 rpm, or from 7 rpm, or from 8 rpm, or from 9 rpm, or from 10 rpm, and preferably to 900 rpm, or to 800 rpm, or to 700 rpm, or to 600 rpm, or to 500 rpm, or to 400 rpm, or to 300 rpm, or to 200 rpm, or to 100 rpm, or to 50 rpm. The rotating extrusion plate may rotate in a clockwise or anti-clockwise direction. The rotating extrusion plate typically has a tip speed of from 0.1 ms⁻¹ to 1600 ms⁻¹, or typically from 10 ms⁻¹, or from 50 ms⁻¹, or from 100 ms⁻¹, or from 150 ms⁻¹, or from 200 ms⁻¹, and typically to 900 ms⁻¹, or to 800 ms⁻¹, or to 700 ms⁻¹, or to 600 ms⁻¹, or to 500 ms⁻¹, or to 400 ms⁻¹. For the purpose of the present invention, the tip speed of the rotating extrusion plate is defined as “the angular velocity of the outer surface or outer edge, of the rotating extrusion plate”. The direction of rotation, or typically the angular direction of rotation, of the rotating extrusion plate is typically perpendicular like, or perpendicular to, the direction of flow of the mixture through the aperture of the rotating extrusion plate.

The rotating extrusion plate is typically a housing enclosing, or at least partially enclosing a volume capable of holding the liquid prior to the extrusion step. The housing rotates around said volume, in a clockwise or anti-clockwise manner. This housing can be a single layer of housing or can be more than one layer of housing, for example an outer layer and an inner layer. For the purposes of the present invention, if the rotating extrusion plate is in the form of a housing for a volume, and the housing contains more than one layer, then only one layer needs to rotate, although it may be preferred for more than one layer, or even all of the layers of the housing, to rotate. If the housing consists of an outer layer and an inner layer, then preferably the outer layer rotates, although the inner layer may rotate, or even both the inner layer and the outer layer rotate.

Preferably, the rotating extrusion plate is cylindrical, spheroid, or cubic in shape. The rotating extrusion plate may be a polyhedral shape, such as a tetrahedral, pentahedral, hexahedron, rhombohedral, heptahedral, octahedral, nonahedral, decahedral, Most preferably, the rotating extrusion plate is cylindrical such as a barrel shape.

It may be preferred that the rotating extrusion plate is at least partially coated, preferably completely coated, with a release agent. The release agent acts to reduce the adhesive properties between the surface of the rotating extrusion plate and the mixture, thus promotes the release of the mixture from the rotating extrusion plate, especially during the extrusion step. Typical release agents comprise hydrophobic material such as wax, oil, grease, combinations thereof, preferably silicone oil. The rotating extrusion plate may also be coated by agents which reduce the interaction between the rotating extrusion plate and the mixture or part thereof. Preferred coatings are plasma coating, polish finishes, or a combination thereof. These coatings may be in addition to a coating comprising release agent. Preferred plasma coatings comprise polyethylene, polypropylene, or a combination thereof. Typical plasma coatings comprise components known under the trade name as Teflon. If the rotating extrusion plate is a housing for a volume capable of holding the mixture, then it may be preferred that both the inner surface or outer surface is coated, or partially coated, with the release agent and/or other coating such as a plasma coating. If the rotating extrusion plate is a housing which comprises more than one layer, then it may be preferred for any layer or part thereof to be coated, or partially coated, with release agent and/or other coating such as plasma coating.

More than one rotating extrusion plate may be used in the process of the present invention, although it is preferred that only one rotating extrusion plate is used herein. Preferred rotating extrusion plates for use herein are those known under the trade names as Rotoform supplied by Sandvik Conveyor GMBH, and Disk Pastillator supplied by Gausche Machinefabriek.

In a preferred process, a receiving surface typically receives the extruded mixture, upon which the extruded mixture forms an extruded particle. The receiving surface can be a belt, a drum, a disc or a plate. If a rotating extrusion plate is used, then the receiving surface can be a shape similar or identical to the rotating extrusion plate. Preferably the receiving surface is a belt or disk. Even more preferably the receiving surface is a conveyor belt or spinning disk.

The rotating extrusion plate can be maintained at any temperature required, this can include heating or cooling the receiving surface, as long as the mixture and/or particle thereon is not freeze-dried. Preferably, the receiving surface is at a temperature of from −40° C. to 200° C., preferably from −20° C., or from −10° C., and preferably to 150° C., or to 100° C., or to 99° C., or to 75° C., or to 60° C. or to 50° C., or to 40° C., or to 30° C. Different areas of the receiving surface can be at different temperatures if required. For example, a first area of the receiving surface can be at a higher temperature than a second area.

It may be preferred that the receiving surface is coated, or at least partially coated, with release agents or other coatings such as plasma coating or polish finishes. Preferred coatings and release agents are described hereinbefore. If the receiving surface is coated, or partially coated, with a release agent, the adhesive properties between the receiving surface and the extruded particle reduced, allowing easier release of said extruded particle from said receiving surface.

As described above, preferred particles comprise a foam, preferably a foam matrix. In a preferred embodiment of the present invention, particles comprising a foam are formed by deliberately introducing a gas into the mixture and/or particle at any stage in the process. The step of introducing a gas into the mixture and/or particle is highly preferred when the particle, or part thereof, is in the form of a foam. The gas is typically incorporated into the mixture and/or particle by any suitable means. The gas is preferably incorporated into the mixture either prior to, or simultaneous to the mixture being extruded through the aperture. Preferably, the gas is incorporated into the mixture prior to the mixture being extruded through the aperture.

The incorporation of gas into the mixture and/or particle causes the mixture and/or particle to foam. Typically this is by physical and/or chemical introduction of the gas into the mixture. Preferred methods are; (a) gas injection (dry or aqueous route), optionally under mixing, high shear mixing (dry or aqueous route), gas dissolution and relaxation including critical gas diffusion (dry or aqueous route), injection of a compressed gas such as a super critical fluid; and/or (b) chemical in-situ gas formation, typically via a chemical reaction(s) of one or more ingredients including formation of CO₂ by an effervescence system; and/or (c) steam blowing, UV light radiation curing.

The gas preferably comprises CO₂, N₂, or a combination thereof such as air. The gas may also be a pressurised gas, or super critical fluid, such as liquid nitrogen or preferably carbon dioxide. If the gas is incorporated in the mixture prior to the mixture being extruded thorough an aperture, then preferably if the gas forms bubbles in the mixture, these bubbles are smaller than the aperture through which the mixture is extruded.

In a preferred embodiment of the present invention, gas is introduced into the mixture by incorporating hollow spheres typically having a mean diameter size of from 1 micron to 150 microns, preferably from 1 micron to 20 microns, in to the mixture.

### EXAMPLES

### Example 1

Process for Preparing Microencapsulated Enzyme Particles

20 g of 10% wt aqueous solution of PVA (Trade Name: Mowiol 4-88) is added to 20 g protease enzyme solution (5% wt active enzyme) to form a mixture. The mixture is added to 180 g of Poly(dimethylsiloxane) (Dow Corning Corporation trade name 200® fluid supplied by Aldrich Chemical Company Inc, 100 cps viscosity) and homogenised by a IKA-WERK JANKE & KUNKEL high speed stirrer a speed of 1000 rpm, to form a two phase mixture. The two phase mixture is homogenised for 5 hours under vacuum 0.025 MPa absolute. The two phase mixture is then centrifuged at 300 rpm to separate solid enzyme particles from the liquid poly(dimethylsiloxane). Some of the poly(dimethylsiloxane) remains on the surface of the solid enzyme particles such that it encloses the solid enzyme particles.

1 g of the solid enzyme particles are added to a solution consisting of 30 g of 30 wt % aqueous solution of PVA (Trade Name: Mowiol 4-88) and 2.5 g of diethylene glycol, and is mixed to form a mixture. The mixture is transferred to a feeder tank of a Sandvik Screen Printer Unit having an aperture size of 600 microns, supplied by Sandvik GmbH, Germany. The mixture is extruded through the apertures onto a receiving belt that is coated with polytetrafluoroethene. The particles are dried on the belt at a temperature of 60° C. to form dried particles. The dried particles are removed from the belt, to form particles in accordance with the present invention.

### Example 2

The particles of example 1 are added to a detergent ingredients to form a solid detergent composition comprising: 1% enzyme particles of example 1; 20% anionic surfactant; 7% Nonionic surfactant; 0.5% Cationic surfactant; 20% zeolite; 10% carbonate; 5% silicate; 35% sulphate; and 1.5% miscellaneous ingredients.

### Example 3

A viscous mixture is prepared by dispersing 237 grams of Poly vinyl alcohol powder (Trade Name: Mowiol 3-83) into 228 grams of water and 35 grams glycerol (Sigma/Aldrich 13487-2). The solution is agitated and heated to 90° C. for one hour to ensure complete dissolution. The resultant mixer is allowed to cool to 25° C. 314 grams of high alkaline protease concentrate (enzyme concentrate 100 mg/g; Aqueous Slurry contains 20% total solids) is added to a cool (25° C.) polymeric viscous solution into a Kenwood-type food mixer. The mixer is operated at maximum speed to foam up the viscous mixture. Air is added within the mixture at a volume ratio of 3 parts air to 1 part viscous mixture as a result of this physical mixing. The said foamed mixture is extruded through a 700 micron diameter aperture using a standard ram extruder (Equipment supplier: Instrom) to form foamed noodles. The noodles are dusted with anhydrous calcium chloride and air dried until the resulting moisture content of the noodles were 5% by weight of noodle. The noodles are cut in a high speed cutter (Kenwood -type chopper) and the resulting particles sieved below 500 microns and above 350 microns. The resultant particles are then coated with poly vinyl alcohol in a lab-scale fluid bed coater (Equipment supplier: Niro). The final coated particles are dusted with sodium thiosulphate in a gentle mixing tumbler.

The resultant particles measured non-detected enzyme dust release in standard attrition impact tests (see for reference: Mojtaba Ghadiri & Dimitris G. Papadopoulos, ‘Impact Breakage of poly-methylmethacrylate (PMMA) extrudates: I. Chipping mechanism. Advanced Powder Technol., Vol. 7, No. 3, pp 183-197 (1996)).

### Example 4

The following examples are meant to exemplify granular laundry detergent compositions of the present invention, but are not necessarily meant to limit or otherwise define the scope of the invention. In the detergent compositions, and unless otherwise specified, the detergent ingredients are expressed by weight of the total compositions. The enzyme particles encompassed in the compositions below can be prepared according to any of the above example and comprise protease, amylase, lipase, cellulase or any other enzyme described above. These enzyme particle comprise one or more enzyme(s) of the same or different type. The abbreviated component identifications therein have the following meanings:

| | |
|---|---|
| LAS | Sodium linear C₁₁₋₁₃ alkyl benzene sulphonate. |
| CxyAS | Sodium C₁ₓ-C_{1y} alkyl sulfate. |
| CxyEz | C₁ₓ-C_{1y} predominantly linear primary alcohol |
| | condensed with an average of z moles of ethylene oxide. |
| CxyEzS | C₁ₓ-C_{1y} sodium alkyl sulfate condensed with an |
| | average of z moles of ethylene oxide. |
| QAS | R₂.N + (CH₃)₂(C₂H₄OH) with R₂ = C₁₂-C₁₄. |
| Silicate | Amorphous Sodium Silicate (SiO₂:Na₂O ratio = 1.6- |
| | 3.2:1). |
| Zeolite A | Hydrated Sodium Aluminosilicate of formula |
| | Na₁₂(A1O₂SiO₂)₁₂. 27H₂O having a primary particle |
| | size in the range from 0.1 to 10 micrometers (Weight |
| | expressed on an anhydrous basis). |
| SKS-6 | Crystalline layered silicate of formula δ-Na₂Si₂O₅. |
| Citrate | Tri-sodium citrate dihydrate. |
| MA/AA | Random copolymer of 4:1 acrylate/maleate, average |
| | molecular weight about 70,000-80,000; or average |
| | molecular weight about 10,000. |
| Perborate | Anhydrous sodium perborate monohydrate or |
| | tetrahydrate. |
| DTPA | Diethylene triamine pentaacetic acid. |
| HEDP | 1,1-hydroxyethane diphosphonic acid. |
| EDDS | Ethylenediamine-N,N′-disuccinic acid, (S, S) isomer in the |
| | form of its sodium salt |
| Protease | Proteolytic enzyme sold under the tradename Savinase |
| | by Novo Nordisk A/S, the “Protease B” variant with the |
| | substitution Y217L described in EP 251 446, the |
| | “protease D” variant with the substitution set |
| | N76D/S103A/V104I and the protease described in |
| | WO99/20727, WO99/20726 and WO99/20723 with the |
| | amino acid substitution set |
| | 101G/103A/104I/159D/232V/236H/245R/248D/252K. |
| Amylase | Amylolytic enzyme sold under the tradename Termamyl ®, |
| | Natalase ® and Duramyl ® available from Novo |
| | Nordisk A/S. |
| Lipase | Lipolytic enzyme sold under the tradename Lipolase, |
| | Lipolase Ultra by Novo Nordisk A/S and Lipomax by Gist- |
| | Brocades. |
| Cellulase | Cellulytic enzyme sold under the tradename Carezyme, |
| | Celluzyme and/or Endolase by Novo Nordisk A/S. |
| CMC | Sodium carboxymethyl cellulose. |
| Brightener | Disodium 4,4′-bis(2-sulphostyryl)biphenyl; or Disodium |
| | 4,4′-bis(4-anilino-6-morpholino-1.3.5-triazin-2-yl) stilbene- |
| | 2:2′-disulfonate; Disodium 4,4′bis (4,6-dianilino-1,3,5- |
| | triazin-2-yl)amino stilbene-2-2′-disulfonate. |

| | I | II | III | IV |
|---|---|---|---|---|
| LAS | 9.0 | 6.0 | 8.0 | 6.0 |
| C₄₅Ex | 3.0 | 4.0 | — | 1.5 |
| C₄₅AS | 6.0 | 4.0 | 6.0 | 5.0 |
| C₄₅AE₃S | 2.0 | 1.0 | 1.0 | 2.0 |
| QAS | — | 1.0 | 1.0 | — |
| DTPA, HEDP and/or EDDS | 0.8 | 0.8 | 0.8 | 0.6 |
| Anhydrous Tri-sodium Citrate and/or | 2.0 | 2.0 | 2.0 | 4.0 |
| anhydrous citric acid | | | | |
| Anhydrous sodium carbonate | 14.0 | 10.0 | 12.0 | 10.0 |
| Anhydrous sodium sulphate | 17.0 | 6.0 | 5.0 | 4.0 |
| Silicate | 1.0 | 1.0 | 1.0 | 2.0 |
| Zeolite A | 22.0 | 18.0 | — | 20.0 |
| SKS-6 | 12.0 | 10.0 | — | 6.0 |
| MA/AA or AA | 0.4 | 0.2 | 0.2 | 0.1 |
| Brightener | 0.15 | 0.2 | 0.2 | 0.18 |
| Sodium tripolyphosphate | — | — | 30.0 | — |
| Smectite clay | — | — | — | 10.0 |
| TAED (Tetraacetyl ethylene diamine) | — | 4.0 | 4.0 | 2.0 |
| Anhydrous Percarbonate | — | 20.0 | 16.0 | — |
| (Na₂CO₃.3H₂O₂) | | | | |
| Perborate | — | — | — | 18.0 |
| Enzymes particles | 0.5 | 2.5 | 2.5 | 5.0 |

| | |
|---|---|
| Minors | Up to 100% |

1. A water-soluble and/or a water-dispersible particle having:
(i) a mean particle diameter of 20 mm or less; and
(ii) a hardness (H) of 500 MPa or less, when measured at a temperature of 20° C., a relative humidity of 40%; and
(iii) a fracture toughness (Kc) of 0.04 MPa.m^{1/2} or greater, when measured at a temperature of 20° C., a relative humidity of 40% and a strain rate of from 1×10⁻⁴ to 1×10⁴ s⁻¹,
said particle comprises an active ingredient and a matrix suitable for delivering said active ingredient to an aqueous environment, and wherein said particle is not freeze dried.

2. A particle according to claim 1, wherein said particle has:
a hardness of 200 MPa or less, when measured at a temperature of 20° C. and a relative humidity of 40%; and/or a fracture toughness of 2 MPa.m^{1/2} or greater, when measured at a temperature of 20° C., a relative humidity of 40% and a strain rate of from 1×10⁻⁴ to 1×10⁴ s⁻¹.

3. A particle according to claim 1, wherein said particle has a ratio of H/Kc² of 312500 Pa⁻¹.m⁻¹ or less.

4. A particle according to claim 1, wherein said particle has a ratio of H/Kc of 12500 m^{-1/2} or less.

5. A particle according to claim 1, wherein said active ingredient is at least partially enclosed by a hydrophobic material.

6. A particle according to claim 1, wherein said active ingredient is in an intimate mixture with a material having a hygroscopicity of 5 wt % or less.

7. A particle according to claim 1, wherein said particle comprises a matrix comprising:
a polymeric material and optionally a plasticizer.

8. A particle according to any preceding claim, wherein said active ingredient comprises an enzyme.

9. A particle according to claim 8, wherein said matrix has a glass transition temperature (Tg) of 60° C. or less.

10. A particle according to claim 1, wherein said particle, or part thereof, is in the form of a foam and wherein said particle, or part thereof, has a relative density of less than 1.

11. A particle according to claim 1, wherein said particle, or part thereof, is in the form of a non-foam, and wherein said particle, or part thereof, has a relative density of 1.

12. A particle according to claim 1, wherein said particle is substantially spherical.

13. A particle according to claim 7 wherein said polymeric material has a weight average molecular weight of from 10000 to 40000 daltons.

14. A process to prepare a particle, said process comprising the steps of:
(a) mixing said active ingredient, or part thereof, and said matrix, or part thereof, to form a mixture;
(b) extruding said mixture through an aperture onto a receiving surface, to form a particle;
(c) drying said particle;
(d) releasing said particle from said receiving surface;
(e) optionally, coating said particle with a polymeric material using standard coating techniques;

15. The process of claim 14 further comprising adding an antioxidant into said mixture and/or particle.

16. The process of claim 14 further comprising introducing a gas into said mixture.

17. A process according to claim 14, wherein said mixture is extruded through an aperture of a rotating extrusion plate onto said receiving surface to form a particle.

18. The process of claim 14, wherein during said extruding step, said mixture has a viscosity of 1000 mPa.s or greater when measured at a shear rate of from 1 to 2000 s⁻¹ and a temperature of 25° C.

19. A process according to claim 14, wherein a release agent or a dusting agent is contacted to said particle and/or to said receiving surface, prior to or during said releasing step.
